(19) United States
(12) Patent Application Publication
(10) Pub. No.: US 2008/0298304 A1
(43) Pub. Date: Dec. 4, 2008

(54) ROUTING METHOD IN WIRELESS MULTI-HOP NETWORK AND COMMUNICATION TERMINAL

(75) Inventors: Tomohiko YAGYU, Tokyo (JP); Shigeru ASAI, Tokyo (JP); Masahiro JIBIKI, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 12/032,333

(22) Filed: Feb. 15, 2008

(30) Foreign Application Priority Data
Aug. 18, 2005 (JP) 2005-237498

(51) Int. Cl. H04Q 7/00

(52) U.S. Cl. 370/328

(57) ABSTRACT

A wireless multi-hop network communication terminal 11 uses a Hello information suppression function 21 to suppress a part of information included in a Hello message for a given time after start-up or a new neighbor terminal is detected, thereby reducing message length. Further, the communication terminal 11 uses a Hello interval adjustment function 22 to adjust and shorten a Hello interval during the suppression of the Hello message length. After canceling the suppression of the Hello message length, the communication terminal 11 calculates and establishes a second Hello interval that is shorter than the usual one. Furthermore, after canceling the second Hello interval, the communication terminal 11 reestablishes the steady-state Hello interval. In this way, the time required for the route convergence among the communication terminals can be shortened when a large number of communication terminals, which are adjacent to one another in a narrow-band wireless network and existent within a wireless communication range, are started up at the same time or when a new communication terminal is added to the network.

### TECHNICAL FIELD

The present invention relates to a routing method in a wireless multi-hop network and a communication terminal and, more particularly, to a routing method and a communication terminal adapted to a situation where a large number of communication terminals (hereinafter, referred to merely as “terminal” or “node”) exist on a network.

### BACKGROUND ART

There is known a wireless network called “wireless multi-hop network. In this wireless network, not only that communication terminal pairs directly communicate with each other by radio, but also that a one first communication terminal can communicate with a one second communication terminal located outside the area that the radio signal of the one first terminal cannot reach. This wireless communication is achieved using other neighbor communication terminals existing within the radio communication range of the one first communication terminal as data relay nodes of the wireless network.

The wireless multi-hop network is constituted by a plurality of communication terminals. Further, the communication terminals each have a router function for forwarding packets that are not destined to them. With the router function, packets can be exchanged between two terminals beyond the radio communication range through another terminal. As a routing protocol that controls the packet forwarding route, in a self-distributed manner, the followings are known. One is a Reactive type protocol that searches for a route so as to determine it at a communication start time. The other is a Proactive type protocol that periodically exchanges a message with neighbor communication terminals to thereby maintain a latest route. Hereinafter, a routing method in a wireless multi-hop network using the Proactive type routing protocol will be described.

In a conventional Proactive type routing protocol (hereinafter, referred to merely as “protocol”), periodic exchange of a neighbor discovery message (referred to as “HELLO message”) is performed and, thereby, terminals (referred to as “neighbor communication terminals” or “neighbor nodes”) existing within the radio communication range is grasped. Subsequently, a topology message including link information between a plurality of neighbor communication terminals is periodically propagated throughout the network. This allows each communication terminal to grasp the network topology (information indicating connection state between respective communication terminals) of the entire network. Then, the shortest route is calculated based on the topology information. In this manner, the communication route control is realized. Such a method is disclosed in the following Non-Patent Document 1, Non-Patent Document 2, and the like.

Hereinafter, a description will be given of an OLSR (Optimized Link State Routing Protocol) disclosed in Non-Patent Document 1.

In the OLSR, a terminal transmits a Hello message at a predetermined transmission interval after start-up. This Hello message can be received only by neighbor terminals located within the radio communication range and is not forwarded to another terminal through the neighbor terminals. When receiving the Hello message from its neighbor terminal, a terminal retains information including the IP address of the neighbor node (neighbor node information) included in the Hello message in a neighbor node table in the form of a list during an effective period (to be described later) included in the Hello message. In the case where the terminal transmits the Hello message next time, it includes a list of the IP addresses of all the neighbor nodes retained in the neighbor node table in the neighbor node information of the Hello message. A terminal that has received the Hello message including the neighbor node information selects, based on the neighbor node information, an MPR (Multipoint Relay) from the neighbor nodes and uses the selected MPR to transmit/forward a TC (Topology Control) message.

The MPR is a set of forwarding nodes for performing forwarding such that a message transmitted by a given terminal can be received by all the terminals existing within a network. When viewed from one source communication terminal, the MPR is selected by calculating a set of neighbor nodes covering all nodes within two hops of the source terminal. The MPR that the source terminal itself selects is notified to the neighbor nodes of the source terminal by the Hello message. With this configuration, when the neighbor node receives from the source terminal a control message, such as a TC message, that needs to be notified to all the terminals within a network, the neighbor node can recognizes that it itself needs to forward the received message. All control messages other than the Hello message are forwarded to all nodes within a network by the MPR. The Hello message is not forwarded any further but received only by the nodes existing within the radio communication range.

The TC message is a message for transmitting link information (normally, link between one terminal and selected MPR node) that one terminal has to all the nodes within a network. This TC message is previously created at a predetermined transmission interval, forwarded by the abovementioned MPR, and notified to all the terminals within a network. The link information of the TC message received by another terminal is stored in a topology table. Each terminal creates a network topology graph from the link information recorded in the topology table, calculates the shortest routes to respective terminals, and sets a forwarding route according to the calculation result.

Non-Patent Document 1: T. Clausen and other one, “Optimized Link State Routing Protocol (OLSR)”, IETF

Non-Patent Document 2: R. Ogier and other two, “Topology Dissemination Based on Reverse-Path Forwarding (TBRPF)”, IETF RFC3684, February 2004

### DISCLOSURE OF THE INVENTION

### Problems to be Solved by the Invention

However, the conventional Proactive type routing method assumes periodical exchange of a Hello message, so that in a narrow-band wireless network, it is necessary to transmit the Hello message at a very long interval (interval at which the Hello message is transmitted) in order to prevent congestion.

Considering, for example an environment where 100 neighbor communication terminals exist in a wireless network having only a 28.8 Kbit/sec bandwidth. In such an environment, even if overhead or packet collision at the data forwarding layer is ignored, it is necessary to set a Hello interval of about 460 seconds (about 7 minutes) in order to suppress a routing message load to 10% or less. Further, when the overhead or packet collision at the data forwarding layer is taken into consideration, a Hello interval double that described above is necessary. In the case where all the terminals are started up at the same time under such a condition, a time at least equal to or more than the Hello interval is required to establish a communicable state between all the terminals, with the result that communication cannot be started immediately after the start-up of the terminals. The same is true in the case where a new terminal is added to a network.

An object of the present invention is to shorten the time required for the route convergence among the communication terminals when a large number of communication terminals, which are adjacent to one another in a narrow-band wireless network and existent within a radio communication range, are started up at the same time or when a new communication terminal is added to the network.

### Means for Solving the Problems

To solve the above object, according to the present invention, there is provided a routing method in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, characterized by comprising the steps of: suppressing the information amount of the Hello message at the time when the Hello message is transmitted at a predetermined transmission interval; and setting the transmission interval to a transmission interval shorter than a Hello message transmission interval in a steady-state while the information amount of the Hello message is suppressed.

The method according to the present invention may further include a step of adjusting the transmission interval in accordance with the number of neighbor nodes detected using the Hello message.

The method according to the present invention may further include the steps of: monitoring the number of the neighbor nodes detected while the information amount of the Hello message is suppressed and canceling the suppression of the Hello message information amount when the number of the neighbor nodes falls below a previously set threshold value; and adjusting the transmission interval after the suppression of the Hello message information amount has been canceled.

The method according to the present invention may further include the steps of: suppressing the information amount of the Hello message when the Hello message is received from a node newly added to the multi-hop network; and resetting the transmission interval to a transmission interval shorter than a Hello message transmission interval in a steady-state while the information amount of the Hello message is suppressed.

### ADVANTAGES OF THE INVENTION

According to the present invention, a network load for exchange of the Hello message can be reduced and route convergence among the communication terminals can quickly be achieved even in the case where a large number of communication terminals existing in a network are started up or where a new communication terminal is added to the network, whereby a time required to establish a communicable state between all the terminals in the network can be reduced.

### BRIEF DESCRIPTION OF THE DRAWINGS

FIG. 1 is a view showing an example of an entire configuration of a wireless multi-hop network according to a first embodiment of the present invention;

FIG. 2 is a view showing an example of a functional configuration of a communication terminal of FIG. 1;

FIG. 3 is a view showing an example of a configuration of a Hello message of the communication terminal of FIG. 1;

FIG. 4 is a flowchart showing an operation sequence of the communication terminal of FIG. 1; and

FIG. 5 is a view for explaining transition of Hello interval in the communication terminal of FIG. 1.

### EXPLANATION OF REFERENCE SYMBOLS

11 to 14: Wireless terminal
20: Wireless communication apparatus
21: Hello information suppression function
22: Hello interval adjustment function
23: Neighbor discovery function
24: Topology discovery function
25: Route calculation function
26: Neighbor node table
27: Topology table
28: Packet forwarding function
29: Routing function
30: Communication application program

### BEST MODE FOR CARRYING OUT THE INVENTION

Now, a preferred embodiment of a routing method in a wireless multi-hop network and a communication terminal according to the present invention will be described with reference to the accompanying drawings.

A wireless multi-hop network (mobile ad-hoc network) according to the present embodiment is a system to which the abovementioned Proactive type protocol (OLSR protocol: Optimized Link State Routing Protocol) of Non-Patent Document 1 has been applied.

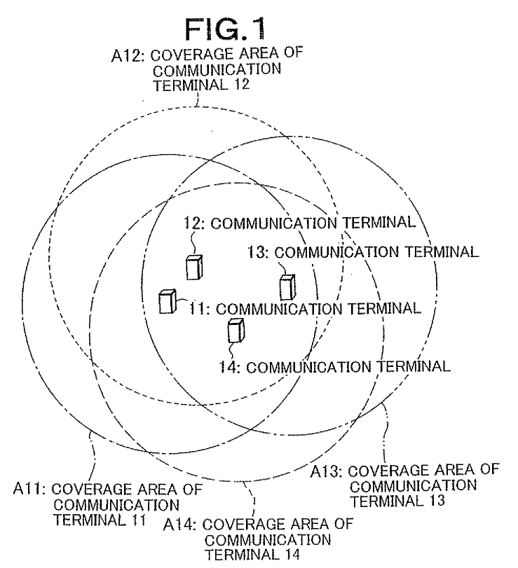

FIG. 1 shows an example of a network configuration in the wireless multi-hop network according to the present embodiment.

In FIG. 1, the wireless multi-hop network includes a plurality of communication terminals 11 to 14. The communication terminals 11 to 14 each act as a node on the wireless network and exchange a control packet between respective nodes by radio in an autonomous manner (A11 to A14 in FIG. 1 denote coverage areas of the communication terminals 11 to 14, respectively). Each of the communication terminals 11 to 14 may be a handheld terminal such as a mobile phone, a note-type PC (Personal Computer) or a radio apparatus installed in a mobile object such as a car.

The communication terminals 11 to 14 each have a unique node ID and IP (Internet Protocol) address. The IP addresses allocated to the communication terminals 11 to 14 are not shared between them and, therefore, can be utilized as the node IDs.

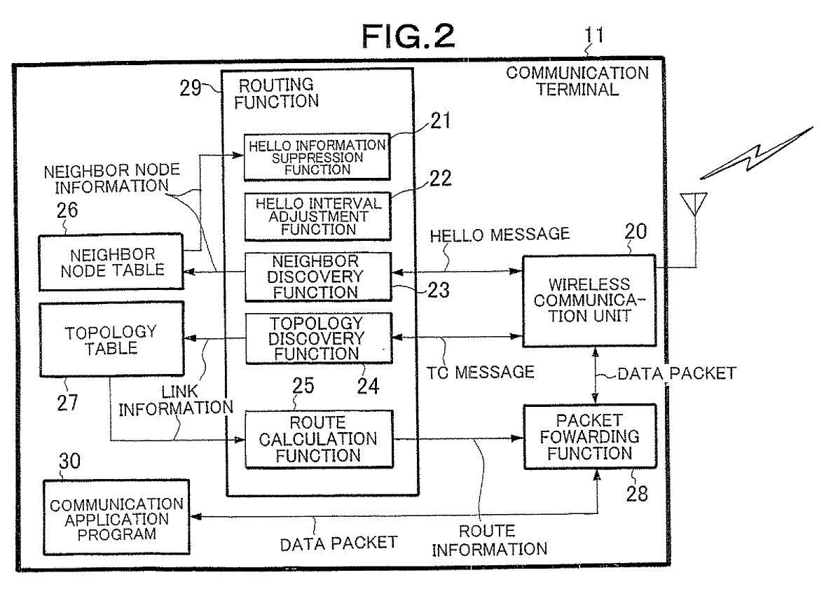

FIG. 2 shows an internal configuration of the communication terminal 11. Other thermals 12 to 14 have the same configuration as that of the communication terminal 11, and descriptions thereof are omitted.

The communication terminal 11 functionally includes a wireless communication unit 20, a neighbor node table 26, a topology table 27, a packet forwarding function 28, a routing function 29, and a communication application program 30.

The wireless communication unit 20 exchanges all routing messages such as a Hello message and TC message and data packets by radio with other communication terminals. The routing messages are exchanged through the routing function 29. The data packets are exchanged under the control of the communication application program 30 through the packet forwarding function 28. The packet forwarding function 28 receives, as an input, route information based on the shortest routes to the other communication terminals calculated by the routing function 29 and, by using the received route information, controls the route of the data packets from the communication application program 30.

Information concerning neighbor nodes is recorded in the neighbor node table 26 according to a Hello message which is received at the wireless communication unit 20 from the neighbor nodes. Information concerning a network topology is recorded in the topology table 27 according to link information included in a TC message which is received at the wireless communication unit 20 directly from another communication terminal within a network or, in some cases, through still another communication terminal. The contents of both the tables 26 and 27 are the same as those described in a known document such as Non-Patent Document 1.

The routing function 29 includes a neighbor discovery function 23 that detects a neighbor node from the received Hello message and records the information in the neighbor node table 26, a topology discovery function 24 that detects link information concerning the network topology from the received TC message and records the information in the topology table 27, and a route calculation function 25 that creates a network topology graph from the link information recorded in the topology table 27 and calculates the shortest routes to the respective terminals.

Further, in the present embodiment, the routing function 29 includes a Hello information suppression function 21 that suppresses the information amount of the Hello message and a Hello interval adjustment function 22 that adjusts Hello interval (interval at which the Hello message is transmitted).

At the start-up time, each communication terminal broadcasts the Hello message in the same manner as the abovementioned OLSR within its coverage area to notify other communication terminals of its existence.

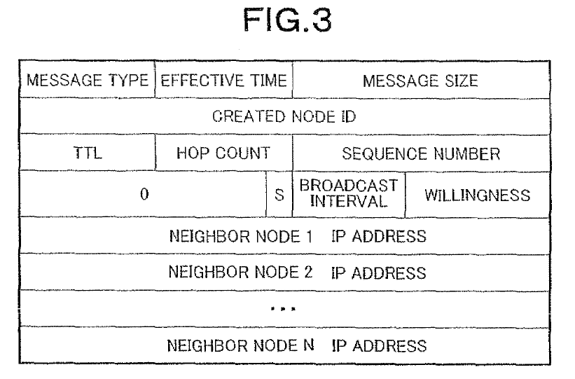

FIG. 3 shows a packet format of the HELLO message. The HELLO message includes the following fields: “message type”, “effective period”, “message size”, “created node ID”, “TTL (Time To Live)”, “hop count”, “sequence number”, “S-bit”, “broadcast interval”, “Willingness”, and “neighbor node IP address”.

“Message type” represents the type (in this case, Hello message) of a message. “Effective period” represents the time period during which the transmission message is effective. “Message size” represents the length of the message. “Created node ID” represents the node ID of a source communication terminal that has created the message. “TTL” represents the maximum hop count of the message to be forwarded. 1 is allocated to the TTL filed of the Hello message, since it is not forwarded. “Hop count” is increased by one every time the message is forwarded. “Sequence number” represents an identification number assigned for uniquely identifying each message and is increased by one every time a message is created. “S-bit” is a flag indicating that the neighbor node information has been omitted in “neighbor discovery stage” to be described later. “Broadcast interval” represents the time interval at which a message is broadcasted. “Willingness” represents the willingness to perform forwarding of a message or data packets and has values from 0 to 7. The neighbor node is selected as a packet forwarding node more often as the value of “Willingness” becomes large. “Neighbor node IP address” represents the IP address of a source terminal of an effective Hello message.

The HELLO message according to the present invention differs from that disclosed in the above Non-Patent Document 1 in that the field of “S-bit” flag is newly added.

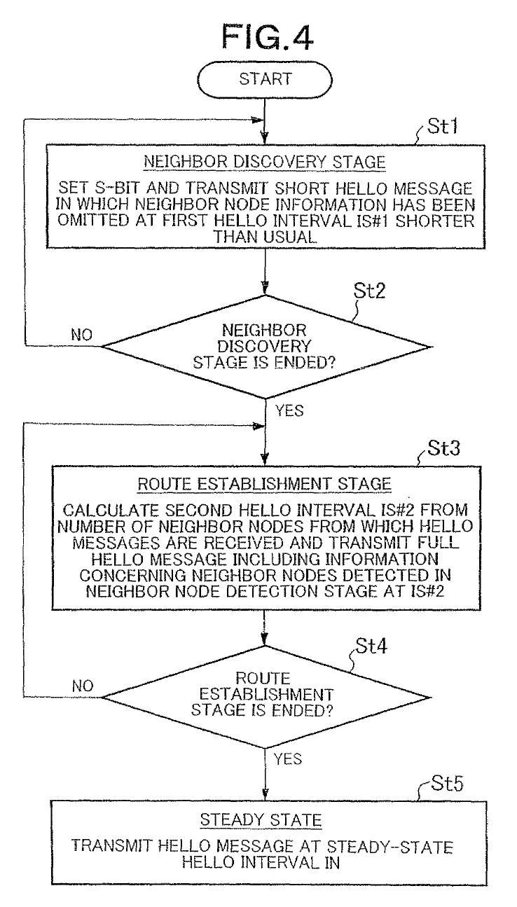

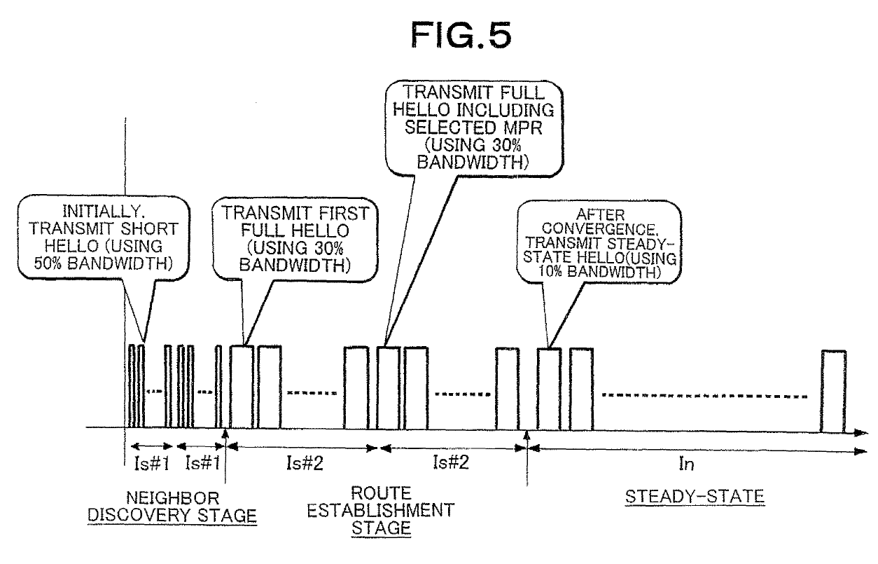

Next, with reference to FIGS. 4 and 5, operation of the present embodiment will be described.

FIG. 4 is a flowchart schematically showing an operation sequence of the communication terminal 11. As shown in FIG. 4, the operation sequence includes the following stages: (1) neighbor discovery stage (step St1); (2) termination determination of neighbor discovery stage (step St2); (3) route establishment stage (step St3); (4) termination determination of route establishment stage (step St4); and (5) steady-state (step St5). The details of the respective stages will sequentially be described below.

(1) Neighbor Discovery Stage (Step St1)

In this stage, the communication terminal 11 transmits the Hello message at a first Hello interval Is#1 previously set by the Hello interval adjustment function 22. This stage is called “neighbor discovery stage”. In the general OLSR, a terminal that has received the Hello message from other terminals stores information of the neighbor nodes in the neighbor node table 26 and includes a list (neighbor node IP address) of recorded IP addresses of the neighbor nodes in the Hello message to be transmitted next time.

On the other hand, in the present embodiment, the communication terminal 11 uses the Hello information suppression function 21 to set the “S-bit” flag in place of including the IP address information of the neighbor nodes in the Hello message at the neighbor discovery stage for the next transmission of the Hello message. With this operation, it is possible to shorten the Hello message length to be exchanged as compared to the case of the general OLSR, thereby completing exchange of the Hello messages with all the neighbor nodes at the Hello interval (first Hello interval) Is#1 shorter than usual.

(2) Termination Determination of Neighbor Discovery Stage (Step St2)

In the case where there is no change between the number of neighbor nodes detected by the time at which the previous Hello interval is ended and number of neighbor nodes detected between the previous Hello interval and current Hello interval, or where a difference between the number of neighbor nodes detected by the time at which the previous Hello interval is ended and number of neighbor nodes detected between the previous Hello interval and current Hello interval falls below a previously set threshold value, the communication terminal 11 determines that it has detected all the neighbor nodes and the flow shifts to the next route establishment stage. Alternatively, the flow may shift to the next stage when a predetermined number of the first Hello intervals have passed.

(3) Route Establishment Stage (Step St3)

After completion of the neighbor discovery stage, the communication terminal 11 uses the Hello interval adjustment function 22 to calculate a second Hello interval from the detected number of neighbor nodes (i.e., from the number of neighbor nodes from which the Hello messages are received). The calculation formula is given as follows.

Is#2=S×N/(B×Pr)

Is#2: Second Hello interval [sec]

S: Size [bit] of Hello message including all neighbor node information N: Detected number of neighbor nodes B: Wireless bandwidth [bit/sec]
Pr: Ratio (0<Pr<1) of bandwidth available for performing routing in route establishment stage

The ratio of bandwidth available for performing routing in the route establishment stage is set to, e.g., 0.3 (30%).

The second Hello interval may be set to a previously set value. In this case, the second Hello interval should be set to a value longer than the first Hello interval Is#1 and shorter than the normal Hello interval.

Each terminal does not set the “S-bit” flag but includes information concerning the neighbor nodes detected in the neighbor discovery stage in the Hello message and transmit the second Hello message in accordance with the second Hello interval Is#2. A terminal that has received the Hello message (full Hello) including the neighbor node information selects the MPR and transmits the TC message and the like. The link information of the TC message received from other terminals is stored in the topology table 27.

(4) Termination Determination of Route Establishment Stage (Step St4)

The operation flow of the communication terminal 11 shifts to the next stage of steady-state at the time point when a predetermined number of the second Hello intervals are ended in the route establishment stage.

(5) Transition of Steady-State (Step St5)

After the route establishment stage is completed, the communication terminal 11 transmits the Hello message at a previously set steady-state Hello interval or interval calculated based on the number of neighbor nodes. The calculation formula is given as follows.

In=S×N/(B×Pn)

In: Steady-state Hello interval [sec]

S: Size [bit] of Hello message including all neighbor node information

N: Detected number of neighbor nodes

B: Wireless bandwidth [bit/sec]

Pn: Ratio (0<Pn<Pr) of bandwidth available for performing routing in steady-state

The ratio Pn of bandwidth available for performing routing in the steady-state is generally set to a value smaller than the Ratio Pr of bandwidth available for performing routing in route establishment stage. For example, when Pr is set to 0.3 (30%), Pn is set to 0.1 (10%).

As described above, the communication terminal 11 uses the Hello information suppression function 21 to suppress a part of information included in the Hello message for a given time after start-up or a new neighbor terminal is detected, thereby reducing message length. Further, the communication terminal 11 uses the Hello interval adjustment function 22 to adjust and shorten the Hello interval during the suppression of the Hello message length. After canceling the suppression of the Hello message length, the communication terminal 11 calculates and establishes the second Hello interval that is shorter than the usual one. Furthermore, after canceling the second Hello interval, the communication terminal 11 reestablishes the steady-state Hello interval.

FIG. 5 shows the Hello interval at the above respective stages. In FIG. 5, Is#1, Is#2, and In denote the first Hello interval, second Hello interval, and steady-state Hello interval, respectively.

In the general OLSR described in Non-Patent Document 1, such adjustment of Hello interval is not made but the Hello message is transmitted at a fixed Hello interval. Further, the neighbor node information in the Hello message is not suppressed in the general OLSR, so that the information amount of the Hello message to be transmitted becomes large, requiring a longer Hello interval for discovering the neighbor nodes.

On the other hand, in the present embodiment, the Hello message is transmitted at the adjusted Hello interval as described above.

That is, in the neighbor discovery stage, the “S-bit” flag is set and a Hello message (short Hello) having a short message length in which the neighbor node information (neighbor node IP addresses) is omitted is transmitted at the first Hello interval Is#1 using, e.g., 50% bandwidth, whereby the neighbor nodes are detected.

Then, in the subsequent step of route establishment stage, the “S-bit” flag is not set but a Hello message (full Hello) including information of all the neighbor nodes detected in the neighbor discovery stage is transmitted at the second Hello interval IS#2 using, e.g., 30% bandwidth and, in this stage, a Hello message (full Hello) including information of the selected MPR is also transmitted at the second Hello interval IS#2 using, e.g., 30% bandwidth, whereby routes are established (converged).

Then, in the next stage of steady-state, a steady-state Hello message is transmitted at a steady-state Hello interval In using, e.g., 10% bandwidth.

Further, in the present embodiment, in the case where a new communication terminal is added to the network where routes have been established and steady-state has been achieved, the same operation as above is performed in order for the new communication terminal to quickly establish routes to other communication terminals, and in order for the other terminals to quickly establish routes to the new communication terminal. That is, the new communication terminal sets the “S-bit” flag and transmits the Hello message at the first Hello interval Is#1. The other terminals that have received the Hello message in which the “S-bit” flag is set also enter the neighbor discovery stage, where they set the “S-bit” flag and transmit the Hello message in which the neighbor node information is suppressed at the first Hello interval Is#1. In this case, the flow shifts to the route establishment stage and steady-state as described above. As a result, routes between a communication terminal newly added to a network and other communication terminals within the network can quickly be established.

Therefore, according to the present embodiment, the following effect can be obtained, as compared to the conventional approach.

The Proactive type routing method in a conventional wireless multi-hop network assumes periodical exchange of a Hello message, so that in the case where a large number of terminals exist in a narrow-band wireless network, it is necessary to transmit the Hello message at a very long Hello interval in order to prevent congestion. In the case where all the communication terminals are started up at the same time under such a condition, or where a new terminal is added to a network, a time at least equal to or more than the Hello interval is required to establish a communicable state between all the terminals, with the result that communication cannot be started immediately after the start-up of the terminals or addition of a new terminal.

On the other hand, the routing method in the wireless multi-hop network according to the present embodiment includes: a step (neighbor discovery stage) of suppressing a part of information included in the Hello message for a given time after start-up or a new neighbor terminal is detected to thereby reduce Hello message length and transmitting the short Hello message at an interval shorter than a normal Hello interval; a step of determining the timing of canceling the suppression of the Hello message length; a step (route establishment stage) of calculating the second Hello interval after canceling the suppression of the Hello message length and transmitting the Hello message at the second Hello interval; and a step (transition to steady-state) of canceling the second Hello interval and reestablishing a steady-state Hello interval.

With the above configuration, a part of information included in the Hello message is suppressed for a given time after start-up or a new neighbor terminal is detected to thereby reduce message length but, instead, the Hello interval is shortened to prioritize the discovery of the neighbor terminals. Further, the second Hello interval that is shorter than the usual one is calculated after the cancel of the suppression of the Hello message length and the Hello message is transmitted using the calculated second Hello interval, whereby the neighbor terminal information can quickly be exchanged. Finally, the second Hello interval for the exchange of the neighbor terminal information is canceled, and the steady-state Hello interval is reestablished.

As a result, a network load for the exchange of the Hello message can be reduced and route convergence among the communication terminals can quickly be achieved even in the case where a large number of communication terminals existing in a network are started up or where a new communication terminal is added to the network, whereby a time required to establish a communicable state between all the terminals in the network can be reduced.

Although an exemplary embodiment of the present invention have been shown and described in detail, it will be apparent to those having ordinary skill in the art that a number of changes, modifications, or alternations to the invention as described herein may be made, none of which depart from the spirit of the present invention. All such changes, modifications, and alternations should therefore be seen as within the scope of the present invention.

For example, a processor (CPU: Central Processing Unit) incorporated in the communication terminal 11 may realize at least a part of the functions of the communication terminal 11 according to the present embodiment using a program code on a recording medium. In this case, the present invention includes the program code and recording medium storing the program code. When the above functions are realized by cooperation between the program code and operating system, communication program, or other application programs, the present invention includes the program code thereof. Further, examples of the recording medium include any type of recording medium, e.g., a semiconductor memory such as an ROM (Read Only Memory) built in the processor or connected thereto, as well as, a disk-shaped recording medium (magnetic disk, optical disk, magnet-optical disk, etc.) communicably connected to the processor through a bus, a tape-shaped recording medium (magnetic tape, etc.), a card-shaped recording medium. Further, as the program code, one of a type that is downloaded from a computer machine such as a communication terminal or server on the wireless multi-hop network may be used.

### INDUSTRIAL APPLICABILITY

The present invention can be applied to a wireless multi-hop network constituted by a plurality of communication terminals, a communication terminal, a routing method used therein, a routing apparatus, a routing program, and a recording medium storing the routing program.

1. A routing method in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the routing method comprising the steps of:
suppressing the information amount of the Hello message at the time when the Hello message is transmitted at a predetermined transmission interval; and
setting the transmission interval to a transmission interval shorter than a Hello message transmission interval in a steady-state while the information amount of the Hello message is suppressed.

2. The routing method in a wireless multi-hop network according to claim 1, further comprising a step of adjusting the transmission interval after the suppression of the Hello message information amount has been canceled in accordance with the number of neighbor nodes detected using the Hello message.

3. The routing method in a wireless multi-hop network according to claim 1, further comprising the steps of:
monitoring the number of the neighbor nodes detected while the information amount of the Hello message is suppressed and canceling the suppression of the Hello message information amount when the number of the neighbor nodes falls below a previously set threshold value; and
adjusting the transmission interval after the suppression of the Hello message information amount has been canceled.

4. The routing method in a wireless multi-hop network according to claim 1, further comprising the steps of:
suppressing the information amount of the Hello message when the Hello message is received from a node newly added to the multi-hop network; and
resetting the transmission interval to a transmission interval shorter than a Hello message transmission interval in a steady-state while the information amount of the Hello message is suppressed.

5. A routing method in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the routing method comprising the steps of:
suppressing a part of information included in the Hello message to shorten Hello message length at the time when the Hello message is transmitted at a predetermined transmission interval;
setting the transmission interval to a first transmission interval shorter than a Hello message transmission interval in a steady-state while the Hello message length is suppressed;
transmitting the Hello message whose message length is suppressed at the first transmission interval;
canceling the suppression of the Hello message length;
setting the transmission interval to a second transmission interval after the suppression of the Hello message length has been canceled;
transmitting the Hello message at the second transmission interval;
canceling the second transmission interval; and
resetting the transmission interval to a Hello message transmission interval in a steady-state after the second transmission interval has been canceled.

6. The routing method in a wireless multi-hop network according to claim 5, wherein
the second transmission interval is calculated by the following formula:
Is#2=S×N/(B×Pr)
where Is#2 [sec] is the second transmission interval, N is the number of neighbor nodes detected using the Hello message, S [bit] is the size of the Hello message including all neighbor node information, B [bit/sec] is the wireless bandwidth of the Hello message, and Pr (0<Pr<1) is the ratio of bandwidth available for performing routing.

7. The routing method in a wireless multi-hop network according to claim 6, wherein
the transmission interval in a steady-state is calculated by the following formula:
In=S×N/(B×Pn)
where In [sec] is the transmission interval in a steady-state, N is the number of neighbor nodes detected using the Hello message, S [bit] is the size of the Hello message including all neighbor node information, [bit/sec] is the wireless bandwidth of the Hello message, and Pn (0<Pn<Pr) is the ratio of bandwidth available for performing routing.

8. The routing method in a wireless multi-hop network according to claim 5, wherein
a part of information included in the Hello message is IP address information of neighbor nodes.

9. A communication terminal used in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the communication terminal comprising:
Hello information suppression means for suppressing the information amount of the Hello message at the time when the Hello message is transmitted at a predetermined transmission interval; and
Hello interval setting means for setting the transmission interval to a transmission interval shorter than a Hello message transmission interval in a steady-state while the information amount of the Hello message is suppressed.

10. The communication terminal used in a wireless multi-hop network according to claim 9, wherein
the Hello interval setting means adjusts the transmission interval after the suppression of the Hello message information amount has been canceled in accordance with the number of neighbor nodes detected using the Hello message.

11. The communication terminal used in a wireless multi-hop network according to claim 9, wherein
the Hello information suppression means monitors the number of the neighbor nodes detected while the information amount of the Hello message is suppressed and cancels the suppression of the Hello message information amount when the number of the neighbor nodes falls below a previously set threshold value, and
the Hello interval setting means adjusts the transmission interval after the suppression of the Hello message information amount has been canceled.

12. The communication terminal used in a wireless multi-hop network according to claim 9, wherein
the Hello information suppression means suppresses the information amount of the Hello message when the Hello message is received from a node newly added to the multi-hop network, and
the Hello interval setting means resets the transmission interval to a transmission interval shorter than a Hello message transmission interval in a steady-state while the information amount of the Hello message is suppressed.

13. A wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, wherein
each of the plurality of communication terminals comprises:
Hello information suppression means for suppressing the information amount of the Hello message at the time when the Hello message is transmitted at a predetermined transmission interval; and
Hello interval setting means for setting the transmission interval to a transmission interval shorter than a Hello message transmission interval in a steady-state while the information amount of the Hello message is suppressed.

14. An apparatus for controlling a route in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the apparatus comprising:
Hello information suppression means for suppressing the information amount of the Hello message at the time when the Hello message is transmitted at a predetermined transmission interval; and
Hello interval setting means for setting the transmission interval to a transmission interval shorter than a Hello message transmission interval in a steady-state while the information amount of the Hello message is suppressed.

15. A program for controlling a route in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the program allowing a computer to execute the steps of:
suppressing the information amount of the Hello message at the time when the Hello message is transmitted at a predetermined transmission interval; and
setting the transmission interval to a transmission interval shorter than a Hello message transmission interval in a steady-state while the information amount of the Hello message is suppressed.

16. A communication terminal used in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the communication terminal comprising:
a Hello information suppression unit configured to suppress the information amount of the Hello message at the time when the Hello message is transmitted at a predetermined transmission interval; and
a Hello interval setting unit configured to set the transmission interval to a transmission interval shorter than a Hello message transmission interval in a steady-state while the information amount of the Hello message is suppressed.

17. The communication terminal used in a wireless multi-hop network according to claim 16, wherein
the Hello interval setting unit is further configured to adjust the transmission interval after the suppression of the Hello message information amount has been canceled in accordance with the number of neighbor nodes detected using the Hello message.

18. The communication terminal used in a wireless multi-hop network according to claim 16, wherein
the Hello information suppression unit is further configured to monitor the number of the neighbor nodes detected while the information amount of the Hello message is suppressed and cancels the suppression of the Hello message information amount when the number of the neighbor nodes falls below a previously set threshold value, and
the Hello interval setting unit is further configured to adjust the transmission interval after the suppression of the Hello message information amount has been canceled.

19. The communication terminal used in a wireless multi-hop network according to claim 16, wherein
the Hello information suppression unit is further configured to suppress the information amount of the Hello message when the Hello message is received from a node newly added to the multi-hop network, and
the Hello interval setting unit is further configured to reset the transmission interval to a transmission interval shorter than a Hello message transmission interval in a steady-state while the information amount of the Hello message is suppressed.

20. A wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, wherein
each of the plurality of communication terminals comprises:
a Hello information suppression unit configured to suppress the information amount of the Hello message at the time when the Hello message is transmitted at a predetermined transmission interval; and
a Hello interval setting unit configured to set the transmission interval to a transmission interval shorter than a Hello message transmission interval in a steady-state while the information amount of the Hello message is suppressed.

21. The wireless multi-hop network according to claim 20, wherein
the Hello interval setting unit is further configured to adjust the transmission interval after the suppression of the Hello message information amount has been canceled in accordance with the number of neighbor nodes detected using the Hello message.

22. The wireless multi-hop network according to claim 20, wherein
the Hello information suppression unit is further configured to monitor the number of the neighbor nodes detected while the information amount of the Hello message is suppressed and cancels the suppression of the Hello message information amount when the number of the neighbor nodes falls below a previously set threshold value, and
the Hello interval setting unit is further configured to adjust the transmission interval after the suppression of the Hello message information amount has been canceled.

23. The wireless multi-hop network according to claim 20, wherein
the Hello information suppression unit is further configured to suppress the information amount of the Hello message when the Hello message is received from a node newly added to the multi-hop network, and
the Hello interval setting unit is further configured to reset the transmission interval to a transmission interval shorter than a Hello message transmission interval in a steady-state while the information amount of the Hello message is suppressed.

24. An apparatus for controlling a route in a wireless multi-hop network that exchanges between a plurality of communication terminals by radio a control packet including a Hello message which is a control message for discovering neighbor nodes to form a multi-hop network where each of the communication terminals serves as a node, retains topology information of the multi-hop network, and controls routes of packets exchanged between the communication terminals based on the topology information, the apparatus comprising:
a Hello information suppression unit configured to suppress the information amount of the Hello message at the time when the Hello message is transmitted at a predetermined transmission interval; and
a Hello interval setting unit configured to set the transmission interval to a transmission interval shorter than a Hello message transmission interval in a steady-state while the information amount of the Hello message is suppressed.

25. The apparatus according to claim 24, wherein
the Hello interval setting unit is further configured to adjust the transmission interval after the suppression of the Hello message information amount has been canceled in accordance with the number of neighbor nodes detected using the Hello message.

26. The apparatus according to claim 24, wherein
the Hello information suppression unit is further configured to monitor the number of the neighbor nodes detected while the information amount of the Hello message is suppressed and cancels the suppression of the Hello message information amount when the number of the neighbor nodes falls below a previously set threshold value, and
the Hello interval setting unit is further configured to adjust the transmission interval after the suppression of the Hello message information amount has been canceled.

27. The apparatus according to claim 24, wherein
the Hello information suppression unit is further configured to suppress the information amount of the Hello message when the Hello message is received from a node newly added to the multi-hop network, and
the Hello interval setting unit is further configured to reset the transmission interval to a transmission interval shorter than a Hello message transmission interval in a steady-state while the information amount of the Hello message is suppressed.
